(19) United States
(12) Patent Application Publication
(10) Pub. No.: US 2012/0102736 A1
(43) Pub. Date: May 3, 2012

(54) MICRO-INJECTOR AND METHOD OF ASSEMBLY AND MOUNTING THEREOF

(75) Inventors: David Livshits, San Francisco, CA (US); Lester Teichner, Chicago, IL (US)

(73) Assignee: TURBULENT ENERGY LLC, Lexington, MA (US)

(21) Appl. No.: 13/294,806

(22) Filed: Nov. 11, 2011

Related U.S. Application Data
(63) Continuation-in-part of application No. 12/529,617, filed on Sep. 2, 2009.
Application No. 12/529,617 is a continuation-in-part of application No. 12/529,625, filed on Apr. 15, 2010.
Application No. 12/529,625 is a continuation-in-part of application No. 12/990,942, filed on Nov. 3, 2010.
Application No. 12/990,942 is a continuation-in-part of application No. 12/886,318, filed on Sep. 20, 2010.
Application No. 12/886,318 is a continuation-in-part of application No. 12/859,121, filed on Aug. 18, 2010.

(51) Int. Cl. B23P 15/00; F02M 43/04

(52) U.S. Cl. 29/888.01

(57) ABSTRACT

The invention relates to a compact device for producing a composite mixture made of two or more fluids, and for aerating and energizing the composite and injecting it into a volume, and more specifically a micro-fuel injector mixing water, air, or any other types of fluid before it is injected into a volume such as a combustion chamber of an engine made of stackable mechanical elements, and the method of assembly and mounting thereof.

### CROSS-REFERENCE TO RELATED APPLICATIONS

This application is based on technology described in part in a family of related applications, including: U.S. Ser. No. 60/970,655, filed on Sep. 7, 2007, and entitled “Method and Device for Preparation and Activation of Fuel”; U.S. Ser. No. 60/974,909, filed on Sep. 25, 2007, and entitled “Method and Device for Preparation and Activation of Fuel”; U.S. Ser. No. 60/978,932, filed on Oct. 10, 2007, and entitled “Method and Device for Preparation and Activation of Fuel”; U.S. Ser. No. 61/012,334, filed on Dec. 7, 2007, and entitled “Method and Device for Preparation and Activation of Fuel”; U.S. Ser. No. 61/012,337, filed on Dec. 7, 2007, and entitled “Method and Device for Preparation and Activation of Fuel”; U.S. Ser. No. 61/012,340, filed on Dec. 7, 2007, and entitled “Fuel Preparation”; U.S. Ser. No. 61/037,032, filed on Mar. 17, 2008, and entitled “Devices and Methods for Mixing Gaseous Components”; U.S. Ser. No. 61/052,317, filed on May 18, 2008, and entitled “Device and Operational Methodology for Producing Water from Air”; and U.S. Ser. No. 61/244,617, filed on Sep. 22, 2009, and entitled “Fluid Mixer with Internal Vortex.”

This application further is based on technology described in part in applications filed off the above family of provisional patent applications, including: PCT Patent Application No. PCT/US2008/075374 entitled “Dynamic Mixing of Fluids” filed on Sep. 5, 2008, PCT/US2008/075366 filed also filed on Sep. 5, 2008, entitled “Method of Dynamic Mixing of Fluids” and national phases U.S. Ser. No. 12/529,617, and European Patent Application No. 08799214, and national phases U.S. Ser. No. 12/529,625, and Brazilian Patent Application No. PI 0816704, Chinese Patent Application No. 2008/80113560, European Patent Application No. 08829128, Indian Patent Application No. 838/KOLNP/2010, and Japanese Patent Application 2010-524174; PCT Patent Application No. PCT/US2009/043547 entitled “System and Apparatus for Condensation of Liquid from Gas and Method of Collection of Liquid” filed on May 12, 2009, and U.S. application Ser. No. 12/990,942; U.S. application Ser. No. 12/886,318 filed on Sep. 20, 2010, and entitled “Fluid Mixer with Internal Vortex”; U.S. application Ser. No. 12/859,121, filed on Aug. 18, 2010, and entitled “Fluid, Composite, Device for Producing Thereof and System of Use”; U.S. application Ser. No. 12/947,991, filed on Nov. 17, 2010, and entitled “Device for Producing a Gaseous Fuel Composite and System of Production Thereof.” All the preceding provisional and non-provisional applications and patents derived there from are incorporated by reference as part of this application in their entirety.

This application continuation-in-part application claims priority from and the benefit of U.S. application Ser. No. 12/529,617, 12/529,625, 12/990,942, 12/886,318, 12/859,121, and 12/947,991, which applications is also hereby incorporated herein fully by reference.

### FIELD OF THE INVENTION

The invention relates to a compact device for producing a composite mixture made of two or more fluids, and for aerating and energizing the composite and injecting it into a volume, and more specifically a micro-fuel injector or a micro-fuel carburetor for mixing water, air, or any other types of fluid before it is injected into a volume such as a combustion chamber of an engine made of stackable mechanical elements, and the method of assembly and mounting thereof.

### BACKGROUND

The ideal mixture of air and gasoline respectively by mass is known as the stoichiometric ratio. For gasoline and air, this ratio is 14.7 to 1, that is, a mixture of 14.7 pounds of air to burn 1 pound of gasoline. This mixture is theoretical and assumes that 100% of the fuel molecules are in contact with air and that every atom of oxygen from the air burns the hydrocarbons in the gasoline. If insufficient air is used, the mixture is called a ‘rich mixture’ and when there is too much air, the mixture is called a ‘lean mixture.’

Diesel engines for example do not use high voltage spark ignition. They rely on compressed air at high pressure and temperature inside of the cylinder to ignite the fuel at a couple of degrees below top dead center. Common compression ratios for diesel combustion range from 14:1 to 18:1. At high temperatures, the diesel fuel reacts with the oxygen in the air and oxidizes the fuel that in turn releases heat and energy in the form of pressure made to work by using a piston. Diesel engines are generally lean burn engines, and use less fuel than rich burn spark ignition engines which are run at the stoichiometric air-fuel ratio.

When the mixture deviates from ideal conditions, the combustion is less than perfect resulting from the creation of pollutants such as unburned hydrocarbons (HC), carbon monoxide (CO), and oxides of nitrogen (NOx). Rich mixtures generate a lot of CO and HC, while lean mixtures generate HC but not from an overabundance of fuel but from misfires. Close to the stoichiometric mix, the system burns hot and while it produces less HC and CO, this is where the production of NOx is at its worst. When recirculation is used in an effort to reduce pollutants, the new mixtures will control NOx by lowering the combustion temperature who in turns increases HC production.

The dynamics of combustion relies on many different factors, including but not limited to the type of fuel burnt, the pressure of the different constitutive elements, the kinetic energy of these constitutive elements, the special distribution of the fuel in the oxidizing gas, etc. In the early 2000's, the Lubrizol® Corporation, prepared and filed U.S. Ser. No. 09/882,764 for the Process for Reducing Pollutants from the Exhaust of a Diesel Engine Using a Water Diesel Fuel in Combination with Exhaust After-Treatments. As part of the process for reducing the level of pollutants in the exhaust of a diesel engine, it was found preferable to use a water-diesel fuel emulsion made of water, diesel fuel, and an emulsifier. The emulsifier allowed for the fuel and water to hold over time as a mixture. As part of this new mixture, the emulsifier included at least one hydrocarbyl-substituted carboxylic acid acylating agent with ammonia or an amine. Lubrizol® the next year prepared and filed U.S. Ser. No. 10/201,008 for an Emulsified Water Fuel Blend Containing an Aqueous Organic Ammonium Salt. The invention described the same mixture as in U.S. Ser. No. 09/882,764 but where at least one aqueous organic ammonium salt is dissolved in the emulsion to help provide the mixture long term stability.

Because of the presence of additives, in the emulsion, Environmental Protection Agency testing was required before this mixture could be used commercially. The Air and Radiation group from the United States EPA published report EPA420-P-02-007 entitled Impacts of Lubrizol's PuriNOx Water/Diesel Emulsion on Exhaust Emissions from Heavy-Duty Engines in a draft format. The next year, the State of California EPA published a report entitled Multi-Media Assessment of Lubrizol's PuriNOx Water/Diesel Emulsion. Of interest is the fact that emulsions of water/diesel fuel significantly reduce the release of NOx and Particulate Matters (PM). What is greatly needed is a stable fuel/water emulsion that can be used as combustible fuel and that does not contain any potentially harmful additive.

Mixing of components such as for example fuel and air, or fuel and water, or any two fluids is generally known. The two fluids are brought in contact and activation energy is introduced into the system using external stimuli. The basic criterion for defining efficiency of a mixing process relates to those parameters that define the uniformity of a resultant mix, the needed energy to create this change in parameters, and the capacity of the mix to maintain those different new conditions. In some technologies, such as the combustion of a biofuel, an organic fuel, or any other exothermic combustible element, there is a desire for an improved method of mixing a combustible element with its oxidant or with other useful fluids as part of the combustion process.

One other important and relevant aspect to the novel technology described in this invention is the concept of miniaturization of structures capable of mixing and the associated creation of micro-emulsions or micro mixed composites. Gas are molecules freely moving in a volume distant from each other. Liquids are less energized molecules in contact like a solid but in a non structured arrangement like sand. Liquids like solids are mostly incompressible. In fluid dynamics, when a liquid moves over a surface, the molecules move and contact an adjacent solid surface creating surface tension, friction, heating, and either a laminar or a turbulent flow based on the different properties of the liquid. As the flow cross area is reduced, the fluid dynamic changes and surface tension, friction, and heating become more important. If a fluid is asked to pass through an opening of the size of a molecule, the molecule while not energetic enough to split from other molecules would react as a gas free from neighboring molecules.

For this reason, the reduction in size of a mixer may be subject to different physical effects resulting in the production of a different mixed composite with different properties. What is needed is a very small device for mixing fluids that takes into consideration the unique dynamic effects occurring when extremely small volume of fluids must be mixed rapidly.

Several technologies are known to help with the combustion of fuel, such as nozzles that spray a fuel within the oxidant using pressurized air, eductors, atomizers, or venturi devices that are sometimes more effective than mechanical mixing devices, these devices generally act upon only one components to be mixed (i.e. the fuel or the oxidant) to recreate a dynamic condition and an increase of kinetic energy. Engines such as internal combustion engines burn fuel to power a mechanical device. In all cases, these engines exhibit less than one hundred percent efficiency in burning the fuel. The inefficiencies result in a portion of the fuel remaining non-combusted after a fuel cycle, the creation of soot, or the burning at less than optimal rates. The inefficiency of engines or combustion chamber conditions can result in increased toxic emissions into the atmosphere and can require a larger amount of fuel to generate a selected level of energy. Various processes have been used to attempt to increase the efficiency of combustion.

In chemistry, a mixture results from the mix of two or more different substances without chemical bonding or chemical alteration. The molecules of two or more different substances, in fluid or gaseous form, are mixed to form a solution. Mixtures are the product of blending, mixing, of substances like elements and compounds, without chemical bonding or other chemical change, so that each substance retains its own chemical properties and makeup. Composites can be the mixture of two or more fluids, liquids, or gas or any combination thereof. For example a fluid composite may be created from a mixture of a fossil fuel and its oxidant such as air. While one type of composite is described, one of ordinary skill in the art will recognize that any type of composite is contemplated.

Another property of composites is the change in overall properties while each of the constituting substances retains their own properties when measures locally. For example, the boiling temperature of a composite may be the average boiling temperature of the different substances forming the composite. Some composite mixtures are homogenous, while other are heterogeneous. A homogenous composite is a mixture whose composition locally cannot be identified, while a heterogenous mixture is a mixture with a composition that can easily be identified since there are two or more phases present.

What is needed is a small mixer capable of mixing dynamically and without external energy two fluids to produce a highly stable micro-emulsion or any other type of fluid composite.

### SUMMARY

The invention relates to a small compact mixing device for producing a composite mixture made of two or more fluids, and for aerating and energizing the composite and injecting it into a volume, and more specifically a micro-fuel injector mixing water, air, or any other types of fluid before it is injected into a combustion chamber of an engine for producing in certain input regimes a stable micro-emulsion of fuel and air.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1A is a side sectional view of a micro-injector for producing a stable micro-emulsion.

FIG. 1B is an isometric view of element 108 as shown at FIG. 1A according to an embodiment of the present disclosure.

FIG. 1C is an isometric view of element 111 as shown at FIG. 1A according to an embodiment of the present disclosure.

FIG. 1D is an isometric view of element 113 as shown at FIG. 1A according to an embodiment of the present disclosure.

FIG. 1E is an isometric view of element 106 as shown at FIG. 1A according to an embodiment of the present disclosure.

FIG. 1F is a side sectional view of element 105 as shown at FIG. 1A according to an embodiment of the present disclosure.

FIG. 2A is an elongated version of the micro-injector of FIG. 1A with three vortex generators made according to another embodiment of the present disclosure.

FIG. 2B is an isometric view of one of the vortex generators of the micro-injector of FIG. 2A.

FIG. 3 is an exploded view of each of the elements of the micro-injector of FIG. 1A.

FIG. 4 is an illustration of the micro-injector of FIG. 1A mounted to a combustion chamber with an air inlet according to an embodiment of the present disclosure.

FIG. 5 is an illustration of the micro-injector of FIG. 1A mounted to a gasoline combustion chamber with an ignition device according to another embodiment of the present disclosure.

FIG. 6A is a front view of a micro-injector with nozzle plate according to an embodiment of the present disclosure.

FIG. 6B is a bottom view of the micro-injector of FIG. 6A.

FIG. 6C is a top view of the micro-injector of FIG. 6A.

FIG. 6D is a view of the micro-injector of FIG. 6A along the cut ling illustrated at FIG. 6B.

FIG. 6E is a perspective view of the micro-injector of FIG. 6D.

FIG. 6F is a perspective view of the micro-injector of FIG. 6A.

FIG. 7A is a plan view of the fixation plate to attach the micro-injector of FIG. 1 into a combustion chamber as shown at FIG. 4.

FIG. 7B is a top view of the fixation plate of FIG. 7A.

FIG. 7C is a perspective view of the fixation plate of FIG. 7A.

FIG. 8A is a side view of a compact micro-injector according to another embodiment.

FIG. 8B is a perspective view of the compact micro-injector of FIG. 8A.

FIG. 8C is a plan view of the compact micro injector of FIG. 8A.

FIG. 9A is the micro-injector of FIG. 7A equipped with a secondary inlet air control system in maximum inlet capacity.

FIG. 9B is the micro-injector of FIG. 7B equipped with a secondary inlet air control system in minimum inlet capacity.

FIG. 10 is a drawing of methods for assembly of a micro-injector and a method for mounting the micro-injector according to an embodiment of the present disclosure.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

The following specification includes by reference all figures, disclosure, claims, headers, titles, of International Applications Nos. PCT/US08/75374, filed Sep. 5, 2008, and entitled “Dynamic Mixing of Fluids”, PCT/US08/075,366, also filed on Sep. 5, 2008, and entitled “Method of Dynamic Mixing of Fluids”, and PCT/US2009/043547, filed on May 12, 2009, and entitled “System and Apparatus for Condensation of Liquid from Gas and Method of Collection of Liquid” along with U.S. nationalized and original filings U.S. applications Nos. 12/529,625, filed Sep. 2, 2009, and entitled “Dynamic Mixing of Fluids”, 12/529,617, filed Sep. 2, 2009, and entitled “Method of Dynamic Mixing of Fluids”, 12/990,942, filed on Nov. 3, 2010, and entitled “System and Apparatus for Condensation of Liquid from Gas and Method of Collection of Liquid”, 12/886,318, filed on Sep. 20, 2010, and entitled “Fluid Mixer with Internal Vortex”, 12/859,121, filed on Aug. 18, 2010, and entitled “Fluid, Composite, Device for Producing Thereof and System of Use”, and 12/947,991, filed on Nov. 17, 2010, and entitled “Device for Producing a Gaseous Fuel Composite and System of Production Thereof.”

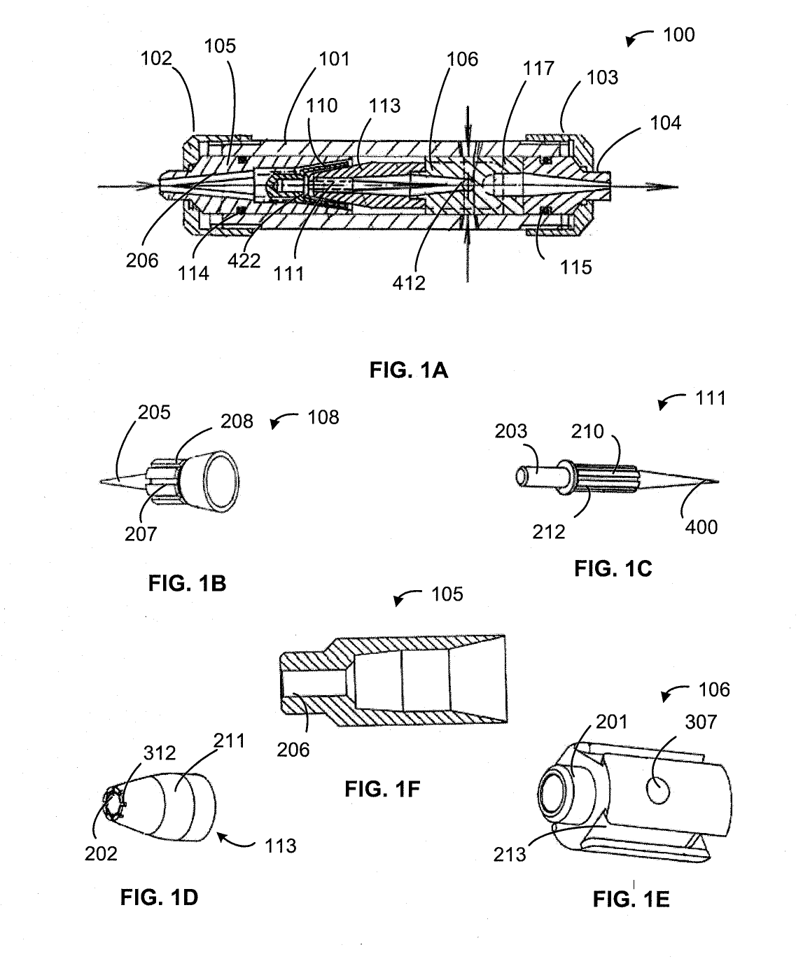

FIG. 1A shows a micro-injector 100 formed of a plurality of stacked pieces 104, 105, 106, 108, 111, and 113 slid into a tube 101 with screwed on end caps 102, 103. In the shown configuration, the micro-injector 100 is compact, and can be easily manufactured as six different pieces with no moving elements are simply assembled easily. For example, in one configuration, one end cap 103 or 102 is screwed, clipped, or secured using any other type of mechanical connection system to the tube 101. By holding the end cap 102, or 103, the six elements are simply slid in turn within the tube 101 in a stacked configuration. For example, if end cap 103 is screwed tightly to the tube 101, the other end of the tube is then lifted up and first of the stacked pieces, namely the outlet piece 104 is pushed down inside the tube. As shown, an outer seal 115 located on the external periphery of the outlet piece 104 allows for fluid inside of the micro-injector 100 to stay confined and also helps to position the outlet piece 104.

Depending on the size of the micro-injector, the air guide piece 106 to be slid in the tube 101 once the outlet piece 104 is inside, can be used to push the outlet piece 104 down. If the micro-injector 100 is too small, a small precision tool can be used to help insert and guide the air guide piece 106. While the outlet piece 104 is shown having an outer seal 115 to help confine the fluids within the tube 101 and the end caps 102, 103. One of ordinary skill in the art will understand that while the use of outer seals is shown, any fluid confinement technology can be used based on the relative size of the micro-injector 100. For example, for a very small micro-injector 100 of less than 1 cm in size, the use of seals may not be optimal for dynamic confinement. Confinement can be made using any technology and also using grease, permanently fusing the pieces into the tube 101, or even by controlling releases and reuse of any fluid released.

In a subsequent step, once the air guide piece 106 is in place within the tube 101, the needle support guide 113 is pushed and placed on the support 201 of the air guide piece 106 as shown with greater detail on FIG. 1E. Once again, the newly inserted piece is slid into the tube 101 may be used to push down the previously pieces. A needle 111 is then gently slid into the round end opening 202 on the needle support guide 113. The pointed end 400 of the needle 111 is very useful to help guide the needle 111 in place on the needle support guide 113. The front tip of the needle 203 is then used to support the inlet fuel splitter 108 slid into place as the next element in the stack. The final piece stacked inside the tube 101 is the inlet 105 also possibly equipped with a confinement system such as an inlet seal 114 to seal the inlet 105 into the tube 101. Finally, once every piece is stacked, the end cap 102 is screwed back over the tube 101 sealing the micro-injector 100 as shown at FIG. 1A.

One of ordinary skill in the art of mechanical design will understand that while the current embodiment describes a structure made of six internal pieces 104, 105, 106, 108, 111, and 113 each stacked within a tube 101 closed at both end with caps 102, 103, the overall structure of the micro-injector 100 can be made of any number of parts and elements to recreate the structure as shown. The currently described best mode is made of pieces that are each to produce and can easily be self-guided when stacked. FIGS. 1B to 1F show five of the six internal pieces in different orientations. Each piece is simple and easy to machine using machining tools.

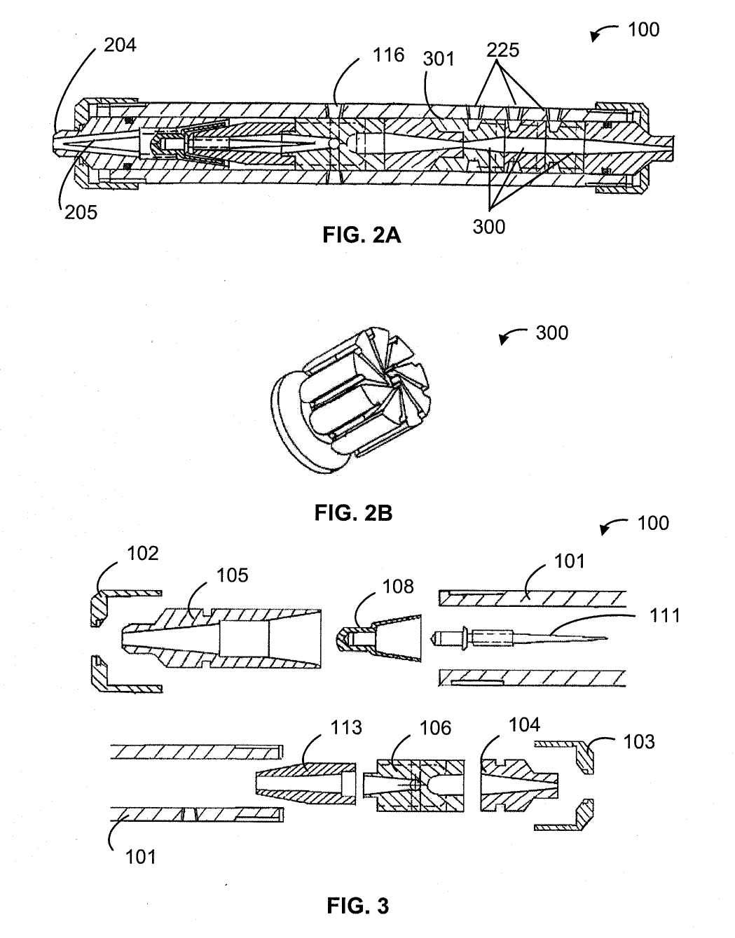

FIG. 1A shows the micro-injector 100 in a closed configuration. In the micro-injector 100 as shown at FIG. 1A, two fluids can be mixed, a primary fluid entering at the orifice 204, and a secondary fluid entering the openings 116. FIG. 2A in contrast shows a micro-injector 100 where three fluids can be mixed, namely a primary fluid entering at the orifice 204, a secondary fluid entering at orifice 116, and a tertiary fluid entering at orifice 225. In one embodiment as shown at FIG. 2A, the tertiary fluid enters via several orifices 225 of the same type and are mixed at subsequent steps in rings 300. One of ordinary skill in the art will recognize that each of the rings 300 could be used to mix in different types of fluids, including a fourth or fifth fluid. In one embodiment, the primary fluid is a fuel, the secondary fluid is air, and the tertiary fluid is also air. In another embodiment, the primary fluid is diesel fuel, the secondary fluid is water, and the tertiary fluid is either water or air where one of the sources of water includes condensates from an engine including hydrocarbon particles.

The micro-injector 100 allows for the primary fluid to travel almost without deviation from the inlet to the outlet. The primary fluid (either air, gas, a liquid, or fuel) enters from the orifice 204 on the left of the figure. The flow is then split around the outer surface of stream expansion needle 205. As a fluid particle travels from the left to the right of the micro-injector 100 as shown, by controlling the angle of the tip of the stream expansion needed 205, the speed of the fluid is controlled. For example, at FIG. 1F, the inside wall 206 of the inlet 105 is show as horizontal while the same wall 206 as shown at FIG. 1A is angled. In the configuration as shown at FIG. 1F, because the area open to the passage of the fluid decreases as it goes over the stream expansion needed 205, the fluid velocity increases proportionally to the decrease in section.

The inlet stream, accelerated or not is then split into a number of faster streams as the primary fluid enters the plurality of channels 207 made in the middle portion 208 of the inlet splitter 108. Based on the passage area of the channels 207, the fluid is increased in velocity proportionally to global reduction in section. For example, if the fluid enters 20 channels and where the area between channels obstructs half of the passage area, the velocity will be doubled. While the channels 207 as shown are of a fixed geometry, what is also contemplated is the use of a variable section to help further energize the streams produced at the outlet of the channels 207. One of ordinary skill in the art will recognize how the different parameters and radii can be changes to control the velocity of the fluid as it enters and transits through the micro-injector 100.

The air guide piece 106 as shown includes a central opening 307 that does not need a seal in the preferred embodiment because of the positive pressure of the secondary fluid entering the central opening 307. In other configurations where the secondary fluid is sucked in via a depression, a seal is needed between the air guide piece 106 and the central openings 307 on the inside of the tube 101. One of ordinary skill will recognize how because of the pressure variations as the fluid travels from the inlet to the outlet of the micro-injector 100, the pressure at the openings 116 can be either positive or negative based on the different parameters in the structure.

The volumetric flow of fluid such as air to be entered through the openings 116 can be calibrated by fixing the size and number of the openings 116, calibrating the pressure of an inlet fluid or gas such as air to be mixed in with the primary fluid coming from orifice 204. The fluid arriving via the openings 116 is pushed perpendicular to the general flow direction of the primary fluid arriving in the orifice 204. The secondary fluid must then change direction by 90 degrees before it is increased in velocity over the needle 400 of the secondary fluid.

As for the primary fluid, the secondary fluid is also split into a multitude of streams over the middle portion 210 of the needle 111 and in most configuration accelerated will be accelerated as it is directed to encounter the primary fluid by a successive reduction in surface area available to the secondary fluid. In some configurations, the secondary fluid, unlike the primary fluid is compressible (i.e. a gas).

The secondary fluid after a first change in direction by 90 degrees 421 is then turned around by 180 degree as it hits a rotation plate 422 and is sent down the internal surface of the reflector plate 110. Holes 312 on the end tip of the needle support guard 211 are made to align with the channels 212 made in the middle portion of the needle 109. As described more fully in the different references incorporated herein, both the primary fluid and the secondary fluids mix in the mixing area outside of the needle support guard 113 before the mixture transits back out via the outlet after passing through the external passages 213 in the air guide piece 106.

FIG. 3 shows an exploded view of FIG. 1A where each of the elements are shown as they can be stacked within the tube 101. As shown at FIG. 1A, a spacer 117 can be used between the outlet piece 104 and the air guide piece 106 of any different thickness. In yet another effort to further energize the exiting stream of the mixture at the outlet end 214 of the outlet piece 104, a narrowing internal wall 216 is used.

FIG. 2A shows the same structure as FIG. 1A with a spacer 117, the tube 101 is longer and includes several cyclone vortex rings 300 as shown at FIG. 2B stacked after the spacer 117. As shown, one of the rings 300 includes an adaptor 301 to make sure the rings 300 can be slid into the micro-injector 100 at the bottom end of the outlet piece 104. As shown, two outlet pieces 104 can be used interchangeably (where one is shown without an outer seal 115).

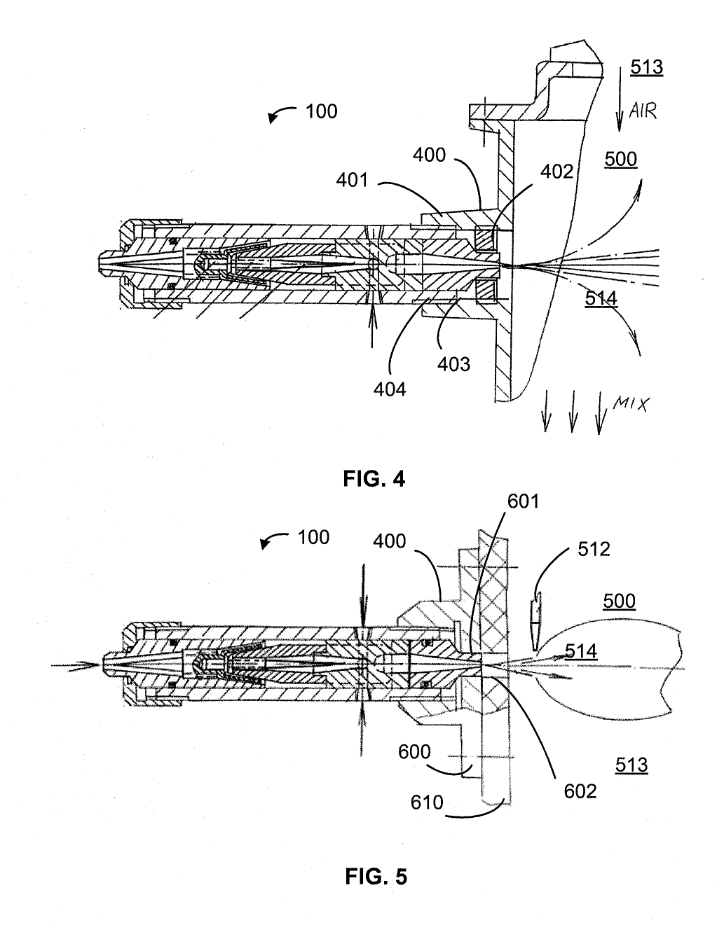

FIGS. 4, and 5 show two possible ways how a micro-injector 100 (shown as the micro injector of FIG. 1A) can be adapted to surface for use. In both of these cases, the micro-injector 100 of FIG. 2A or any other type of micro-injector 100 could be used. At FIG. 4, the combustion chamber 500 where the micro-injector 100 is mounted and releases a spray includes an interface 400 designed to replace the end cap 103. The interface 400 includes an opening 401 with a nozzle support 402 where the tip of the outlet piece 104 is inserted or screwed into. As shown, the inner wall 403 of the opening 401 at the external end can include threads 404 for screwing the tube 101 directly into the opening 401 for easy mounting. While one type of easy fixation is shown, what is contemplated is any mechanical system that can be used to secure a micro-injector at an interface 400.

In the example shown at FIG. 4, the method for mounting the micro-injector 100 to the combustion chamber 500 includes the steps of first holding the end cap 102 and fixing the tube 101 to the end cap 102 either by screwing or any other fixation method. Holding the end cap 102 and the tube 101 with the opened portion of the tube 101 upwards, then the internal stackable elements are then slid in successively starting with the inlet 105. The inlet air splitter 108 is then slid over the inlet 105. Because the needle 111 is sometimes difficult to align at the tip 203, in one embodiment if the inlet air splitter 108 is not fully dropped down the tube 101, the needle 111 at the tip 203 is gently put in the splitter 108 and the support guide 113 can be guided in place over the pointed end 400 of the needle 111. Finally the air guide piece 106 and the outlet piece 104 are stacked before a user can then screw or attach the opened end of the tube 101 to the interface 400.

At FIG. 4, the configuration as shown may be as part of a diesel fuel combustion chamber is shown. FIG. 5 shows the configuration within a gasoline fuel combustion chamber where an ignition device 512 is needed. At FIG. 4, air 513 enters and is mixed with the output of the mixture 514 within the volume 500.

FIG. 5 shows an interface 400 with an opening 401, a support plate 600 screwed to the wall 610 combustion chamber where the interface 400 includes a release opening 601 that is aligned with a chamber opening 602 on a wall 610 using bolts or other fixation means (shown only as lines). At FIG. 5, much like FIG. 4, the end cap 103 used on FIGS. 1A and 2A is not needed and is replaced by the interface 400. While this configuration is shown, one of ordinary skill in the art will recognize that interface 400 may be designed to accommodate the entire micro-injector 100 equipped with both end caps 102, 103. FIG. 5 shows a configuration where an ignition device 512 is used in the combustion chamber 500 to help ignite a mixture being injected from the micro-injector 100. One of ordinary skill in the art will recognize that the configurations shown at FIGS. 4, and 5 are only exemplary of the multiple different configurations where the micro-injector 100 can be attached.

Because of the simplicity, compactness, and ease modular design of the micro-injector 100, one of ordinary skill with recognize that the structure as a whole can be miniaturized until it reaches very small dimensions. For example, the mixer can be conceived for use in extremely small systems, for example for MEMS where mixing or injection is needed (Micro-Electro-Mechanical-Systems).

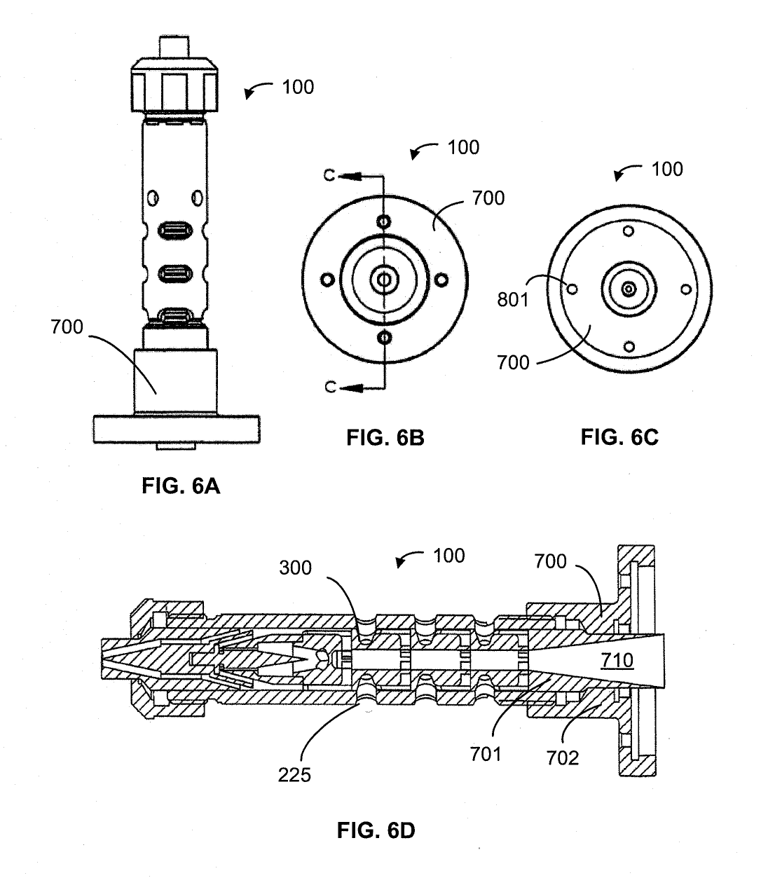

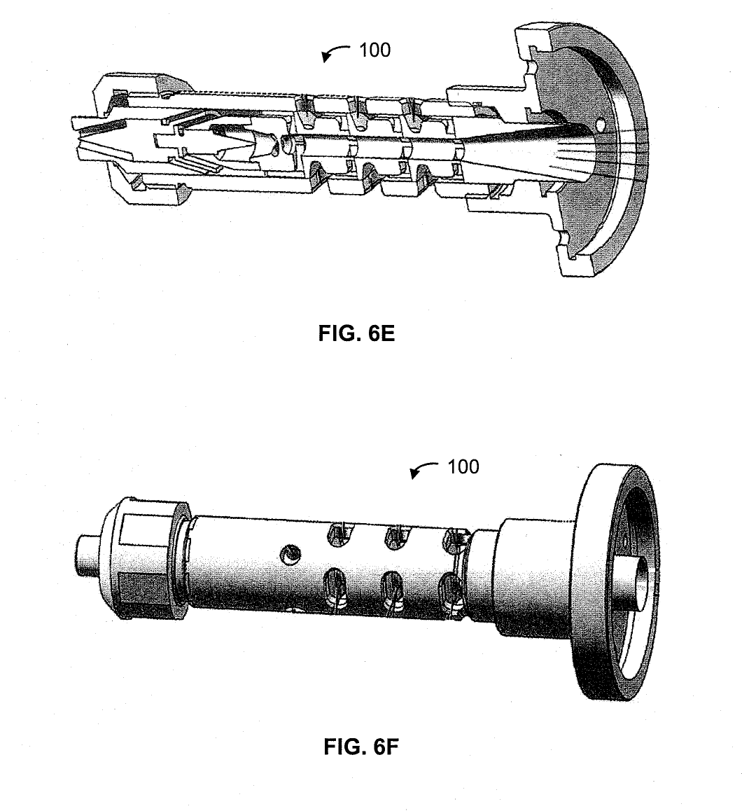

FIG. 6A to 6F are different views of the micro-injector 100 connected to a conical base plate adaptor 700. The interface 400 described at FIGS. 4, and 5 is round and the mixed spay can be released using a gradually opening conical shape 710 formed in a adaptor piece 701 locked into a connection plate 702. As shown, at FIG. 6D, the adaptor piece 701 in the method described above, is stacked in the tube 101 on top of the last ring 300 and the connection plate 702 is then screwed on the external threads of the tube 101 to closed the structure. One of ordinary skill will recognize that the micro-injector 100 may be designed where the adaptor piece 701 and the connection plate 702 are adapted to specific types of equipment or to replace existing injectors. What is also contemplated is the design of an end cap 102 also with external features to be adapted to existing or standard equipment from a source of fluid for mixing. For example, if commercial injectors are connected using a pressurized quick connect connector, the end cap 102 may be adapted with a quick connect or the tube end 101 can be equipped to be mounded with a quick connect. Greater details of the connection plate 702 is given at FIGS. 6A to 6C. As shown, four holes 801 as shown at FIG. 6C are placed at 90 degree angles around the opening to screw the plate 702 to any mechanical structure. FIGS. 6E and 6F are three dimensional representations of the micro-injector 100 as shown at FIGS. 6A to 6D.

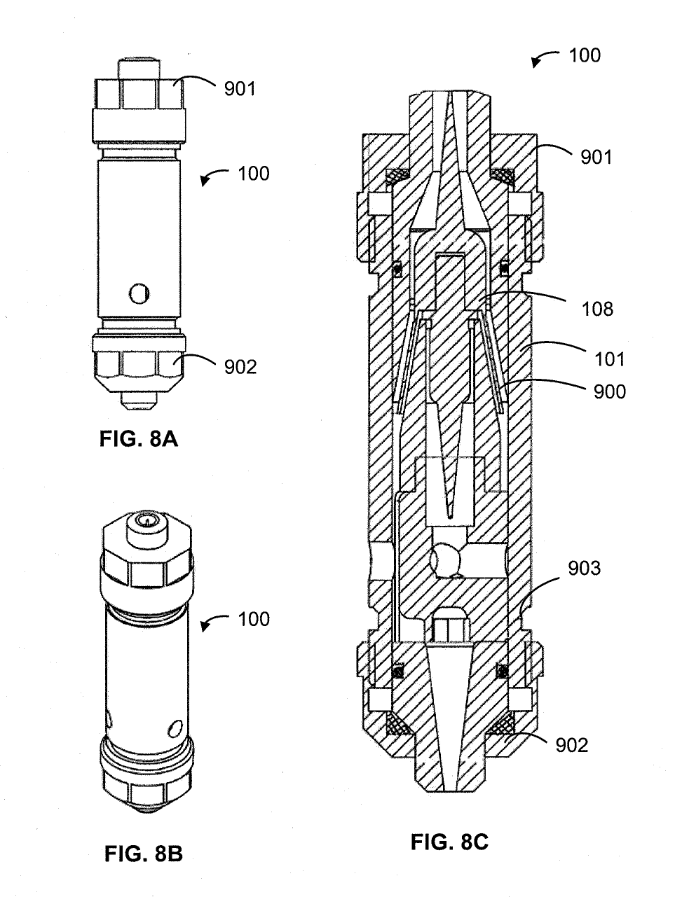

FIG. 8A to 8C show end caps with tabs 901, 902 on both end caps 102, 103 for connection or removal using a hexagonal shaped tool. FIG. 8C is a plan view of the micro-injector 100 and clearly shows the compactness of the different elements within the micro-injector 100. One well documented problem with mixing devices is cavitations and vibrations of the different elements within the structure. To help limit and/or eliminate inherent vibratory modes, the micro-injector 100 does not include any moving part and the only thin walled element is part of the inlet air splitter 108 and is reinforced because it is in the shape of a ring 900 with both fluids travelling in the same direction on both sides. The micro-injector 100 is also relatively symmetrical as to the axial line as secondary and tertiary fluids are introduced at opposed and symmetrical openings on the tube 101. Maintenance and repair of the micro-injector and its different elements is also greatly simplified by the compactness of the design, the ease in stacking of the elements, and the location of the different seals. The tube 101 can also be designed with grooves 903 or other features.

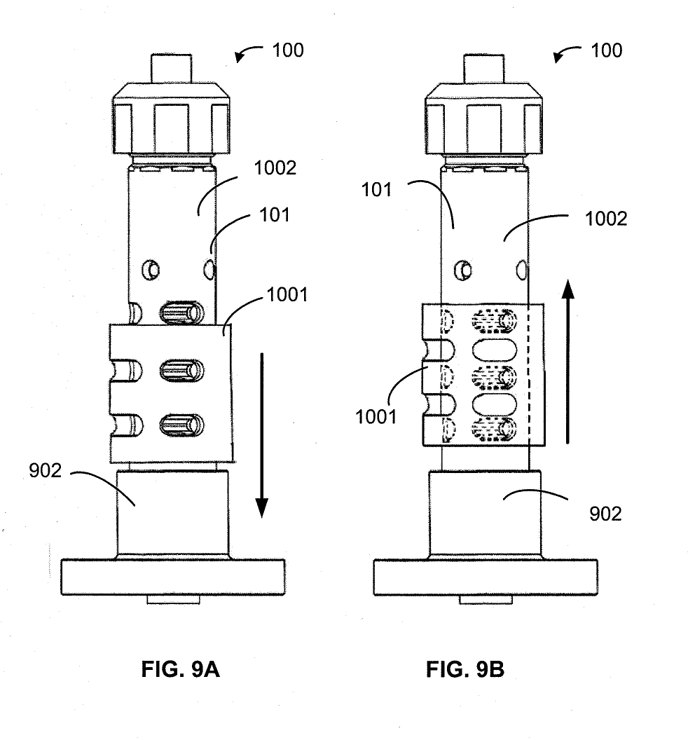

FIGS. 9A and 9B show the configuration where a tertiary air control ring 1001 can be slid over the outer surface 1002 of the tube 101 using an external system (not shown). In the micro-injector 100 as shown at FIG. 6D, four openings 225 are made at the four sides of each of the three rings 300 inside of the micro-injector 100. At a minimal flow of air, all 12 of the openings 225 are blocked as shown at FIG. 9B, and at a maximum flow of air, none of the openings 225 are blocked as shown at FIG. 9A. While a large range of different systems can be used to regulate the incoming flow of tertiary fluid in the micro-injector 100, what is shown at FIGS. 9A and 9B is a contemplated best mode using a single ring 1001 that when moved by half of the distance between two adjacent holes 225 along the length of the micro-injector 100 to go from a closed inlet configuration as shown at FIG. 9B to an open configuration as shown at FIG. 9A. What is also contemplated is the placement of the ring 1001 at an intermediary position between the fully opened configuration of FIG. 9A and the fully closed configuration of FIG. 9B.

There are numerous advantages of a compact and easy to assemble micro-injector 100. The simplicity of the design in conjunction with a design without any moving part and mixing dynamically using the kinetic energy of the fluids to be mixed allows for a reduction in the shape and size of the mixer. Each of the elements as shown can be molded or machined. Cylindrical designs are also know to be strong and durable and less subject to mechanical fatigue or stress fractures. The use of end caps 102 and 103 also allows to provide a double level of confinement, in case of rupture of the seals 114 or 115 by placing a seal between the tip of pieces 105, 104 and the end caps 102 and 103 and making the connection also leak proof.

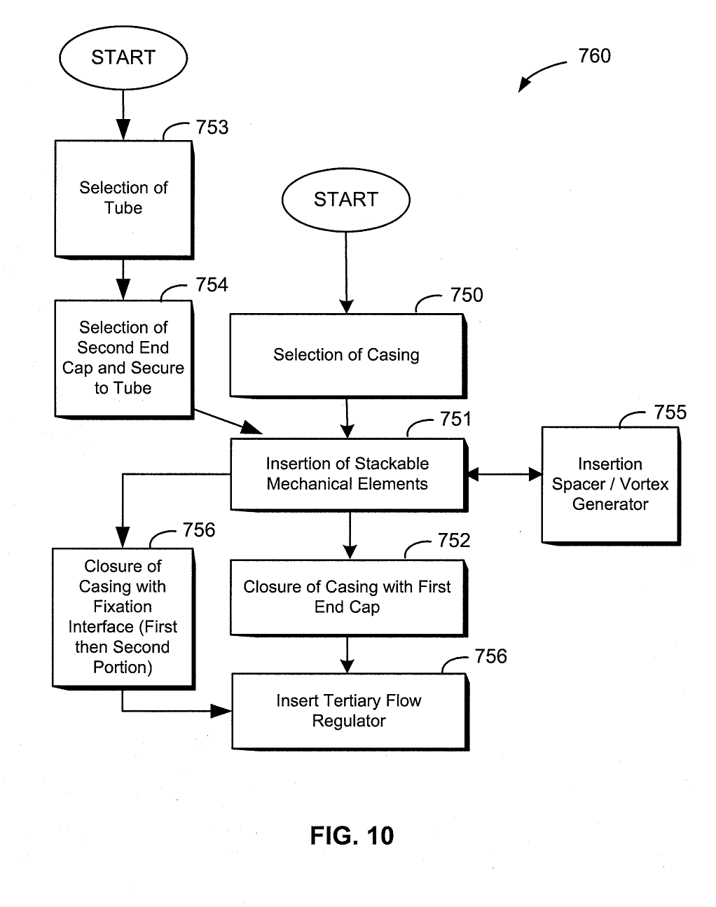

What is also contemplated and illustrated at FIG. 10 is a method of assembly of a micro-injector 100. The method 760 includes the steps of selecting a casing 750 with an internal fluid mixing volume, at least one primary fluid inlet aperture, at least one secondary fluid inlet aperture and an open end. Once the casing is selected 750, a plurality of stackable mechanical elements are slid 751 through the open end of the casing in a predetermined order and orientation. Once all of the elements are stacked, the casing is closed 752 by selecting and then attaching a first end cap with an outlet aperture for the passage of a mixture formed from at least a primary fluid and a secondary fluid, and thus forming a confined volume within the internal fluid mixing volume for the passage of the primary fluid from the at least one primary fluid aperture to the outlet and the secondary fluid from the secondary fluid inlet aperture to the outlet. The stackable mechanical elements within the casing 750 also form a mixer within the internal fluid mixing volume to mix the primary fluid and the secondary fluid.

As shown and described above, the step of selecting the casing can include the steps of selecting a tube 753 with a first mating mechanical interface, selecting a second end cap 754 with a second mating mechanical interface, and securing the first mating interface to the second mating interface. The step of sliding a plurality of stackable mechanical elements 751 can also include sub steps of stacking an inlet, a primary fluid splitter, a secondary fluid splitter, and an outlet. As described above, the inlet is shown as element 105, the primary fluid splitter shown as element 108, the secondary fluid splitter elements 113, 106 and 111, and the outlet element 104. While one configuration is shown, what is contemplated is the stacking of any configuration of elements within the casing.

In yet another embodiment, the casing includes least a tertiary fluid aperture, and the method 760 includes the step of stacking a vortex generator and/or a spacer 755 between the secondary fluid splitter and the outlet so the vortex generator aligns with the at least a tertiary fluid aperture within the casing. In yet another embodiment, the method includes the step of sliding over the casing a tertiary fluid flow regulator 756 for movement between an opened air flow configuration and a closed air flow configuration.

The method can also be used to mount a micro-injector to a volume where injection is needed. As part of this method of mounting the casing by attaching the casing with stacked mechanical elements to a fixation interface 756 with an outlet aperture for the passage of a mixture formed from at least a primary fluid and a secondary fluid, and forming a confined volume within the internal fluid mixing volume for the passage of the primary fluid from the at least one primary fluid aperture to the outlet and the secondary fluid from the secondary fluid inlet aperture to the outlet, and wherein the stackable mechanical elements form a mixer within the internal fluid mixing volume to mix the primary fluid and the secondary fluid.

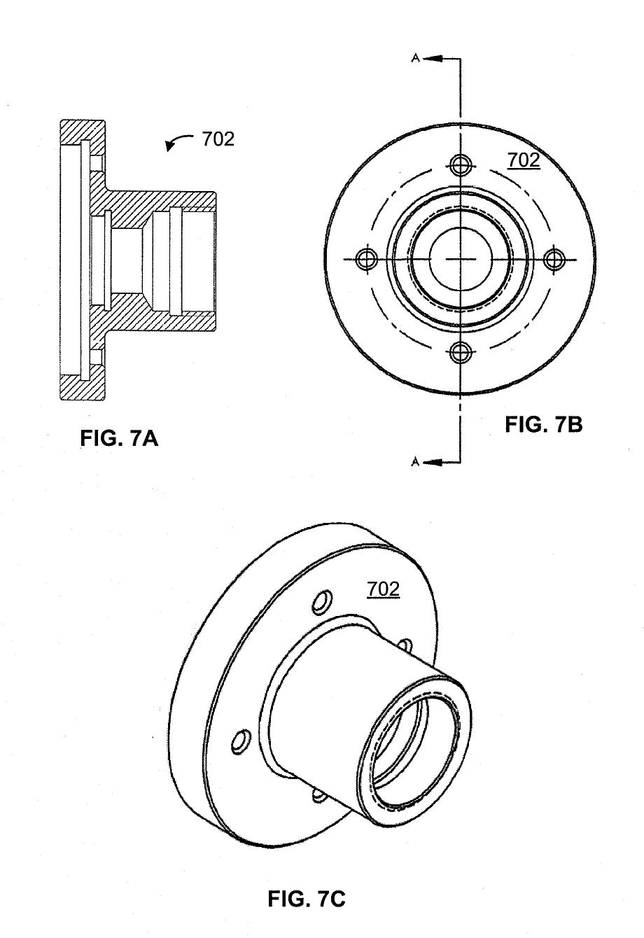

The fixation interface can be made of at least a first piece and a second piece, and the step of closing the casing comprising the steps of securing the first piece to the casing, and securing the casing with the first piece to the second piece. As shown in FIGS. 1 to 9, the first piece is selected from a group comprising of an adaptor piece 701, a nozzle support 402, and a support plate 600, and the second piece is selected from a group comprising of a connection plate 702, an interface 400, and a wall 610.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A method of assembly of a micro-injector, the method comprising the steps of:
selecting a casing with an internal fluid mixing volume, at least one primary fluid inlet aperture, at least one secondary fluid inlet aperture and an open end;
sliding through the open end a plurality of stackable mechanical elements in a predetermined order and orientation; and
closing the casing by selecting and then attaching a first end cap with an outlet aperture for the passage of a mixture formed from at least a primary fluid and a secondary fluid, and forming a confined volume within the internal fluid mixing volume for the passage of the primary fluid from the at least one primary fluid aperture to the outlet and the secondary fluid from the secondary fluid inlet aperture to the outlet, and wherein the stackable mechanical elements form a mixer within the internal fluid mixing volume to mix the primary fluid and the secondary fluid.

2. The method of assembly of claim 1, wherein the step of selecting the casing includes the steps of selecting a tube with a first mating mechanical interface, selecting a second end cap with a second mating mechanical interface, and securing the first mating interface to the second mating interface.

3. The method of assembly of claim 1, wherein the step of sliding the plurality of stackable mechanical elements comprises the subsequent steps of stacking an inlet, a primary fluid splitter, a secondary fluid splitter, and an outlet.

4. The method of assembly of claim 3, wherein the step of stacking the secondary fluid splitter comprises the steps of stacking a needle, a needle support guard, and a air guide piece.

5. The method of assembly of claim 3, wherein the casing further includes at least a tertiary fluid aperture, and the step of stacking the plurality of mechanical elements includes the step of stacking a vortex generator between the secondary fluid splitter and the outlet so the vortex generator aligns with the at least a tertiary fluid aperture within the casing.

6. The method of assembly of claim 3, wherein the step of stacking the plurality of mechanical elements includes the step of stacking a spacer between the secondary fluid splitter and the outlet.

7. The method of assembly of claim 5, further comprising the step of sliding over the casing a tertiary fluid flow regulator for movement between an opened air flow configuration and a closed air flow configuration.

8. A method of mounting a micro-injector to a volume where injection is needed, the method comprising the steps of:
selecting a casing with an internal fluid mixing volume, at least one primary fluid inlet aperture, at least one secondary fluid inlet aperture and an open end;
sliding through the open end a plurality of stackable mechanical elements in a predetermined order and orientation; and
closing the casing by attaching the casing with stacked mechanical elements to a fixation interface with an outlet aperture for the passage of a mixture formed from at least a primary fluid and a secondary fluid, and forming a confined volume within the internal fluid mixing volume for the passage of the primary fluid from the at least one primary fluid aperture to the outlet and the secondary fluid from the secondary fluid inlet aperture to the outlet, and wherein the stackable mechanical elements form a mixer within the internal fluid mixing volume to mix the primary fluid and the secondary fluid.

9. The method of mounting a micro-injector to a volume where injection is needed of claim 8, wherein the interface is adapted to attach a casing with an end cap.

10. The method of mounting a micro-injector to a volume where injection is needed of claim 8, wherein the fixation interface is made of at least a first piece and a second piece, the step of closing the casing comprising the steps of securing the first piece to the casing, and securing the casing with the first piece to the second piece.

11. The method of mounting a micro-injector to a volume wherein injection is needed of claim 10, wherein the first piece is selected from a group comprising of an adaptor piece, a nozzle support, and a support plate, and the second piece is selected from a group comprising of a connection plate, an interface, and a wall, and wherein the method further includes the step of confining the first piece to the second piece.

12. The method of mounting of claim 8, wherein the step of selecting the casing includes the steps of selecting a tube with a first mating mechanical interface, selecting a second end cap with a second mating mechanical interface, and securing the first mating interface to the second mating interface.

13. The method of assembly of claim 8, wherein the step of sliding the plurality of stackable mechanical elements comprises the subsequent steps of stacking an inlet, a primary fluid splitter, a secondary fluid splitter, and an outlet.

14. The method of assembly of claim 13, wherein the step of stacking the secondary fluid splitter comprises the steps of stacking a needle, a needle support guard, and a air guide piece.

15. The method of assembly of claim 13, wherein the casing further includes at least a tertiary fluid aperture, and the step of stacking the plurality of mechanical elements includes the step of stacking a vortex generator between the secondary fluid splitter and the outlet so the vortex generator aligns with the at least a tertiary fluid aperture within the casing.

16. The method of assembly of claim 13, wherein the step of stacking the plurality of mechanical elements includes the step of stacking a spacer between the secondary fluid splitter and the outlet.

17. The method of assembly of claim 15, further comprising the step of sliding over the casing a tertiary fluid flow regulator for movement between an opened air flow configuration and a closed air flow configuration.

18. The method of assembly of claim 10, wherein the volume where injection is needed is a combustion chamber of diesel engine.

19. The method of assembly of claim 10, wherein the volume where injection is needed is a combustion chamber of a gasoline engine.

20. The method of assembly of claim 17, wherein the step of sliding the tertiary fluid flow regulator is done using an external movement apparatus.
